(19) United States
(12) Patent Application Publication
(10) Pub. No.: US 2003/0173821 A1
(43) Pub. Date: Sep. 18, 2003

(54) Bicycle hub for mounting intersecting pairs of spokes

(76) Inventor: Chao-Ying Chen, Tainan Hsien (TW)

Correspondence Address: WHYTE HIRSCHBOECK DUDEK S C, 111 EAST WISCONSIN AVENUE, SUITE 2100, MILWAUKEE, WI, 53202

(21) Appl. No.: 10/282,614

(22) Filed: Oct. 29, 2002

(30) Foreign Application Priority Data
Mar. 15, 2002 (TW) 091203166

(51) Int. Cl. B60B 21/06

(52) U.S. Cl. 301/59

(57) ABSTRACT

A bicycle hub is to be installed on a wheel axle, and includes a tubular body and an annular mounting seat provided on one end of the tubular body. The mounting seat has first and second end walls which are opposite to each other along an axis of the wheel axle, and an inner wall surface facing the axis and including a plurality of indented spoke mounting sections that are displaced angularly from one another and that are indented in radial directions. Each spoke mounting section is defined by a pair of inclined side walls and a bottom wall extending between the inclined side walls. The mounting sleeve is formed with a plurality of spoke mounting holes, each of which extends from a respective one of the inclined side walls to an outer wall surface of the mounting sleeve.

### CROSS-REFERENCE TO RELATED APPLICATION

This application claims priority of Taiwanese Application No. 091203166, filed on Mar. 15, 2002.

### BACKGROUND OF THE INVENTION

1. Field of the Invention

The present invention relates to a bicycle hub, more particularly to a bicycle hub for mounting intersecting pairs of spokes thereon.

2. Description of the Related Art

Referring to FIG. 1, a conventional bicycle hub 1 is shown to include an inner sleeve 11 to be sleeved on a wheel axle, an outer sleeve 12 disposed around the inner sleeve 11, and four radial flanges 13 extending integrally in radial outward directions from the outer sleeve 12. The radial flanges 13 are angularly displaced from one another. Each radial flange 13 is formed with a pair of spoke mounting holes 15 for mounting a pair of spokes 14 using a pair of spoke fasteners 16. Each of the spokes 14 is inclined relative to the respective radial flange 13, and intersects one of the spokes 14 mounted on an adjacent radial flange 13.

It is noted that tension of the spokes 14 is applied to the radial flanges 13 such that stress concentrates on the radial flanges 13. The radial flanges 13 are thus susceptible to breakage.

### SUMMARY OF THE INVENTION

The main object of the present invention is to provide a bicycle hub that enables uniform distribution of the tension of the spokes over the hub to overcome the aforementioned drawback of the prior art.

Accordingly, the bicycle hub of the present invention is adapted to be installed on a wheel axle, and includes a tubular body and an annular mounting seat. The tubular body is adapted to be sleeved on the wheel axle, and has opposite end portions which are opposite to each other along an axis of the wheel axle. The mounting seat is provided on one of the end portions of the tubular body, and has an annular mounting sleeve which is disposed around the axis of the wheel axle and which has a first end wall facing the other one of the end portions of the tubular body, a second end wall opposite to the first end wall along the axis of the wheel axle, an inner wall surface facing the axis of the wheel axle, and an outer wall surface opposite to the inner wall surface in radial directions with respect to the axis of the wheel axle. The inner wall surface includes a plurality of indented spoke mounting sections which are displaced angularly from one another and which are indented in the radial directions. Each of the spoke mounting sections is defined by a pair of inclined side walls spaced apart from each other in a circumferential direction with respect to the axis of the wheel axle, and a bottom wall extending between the inclined side walls. The inclined side walls are inclined with respect to the bottom wall. The mounting sleeve is formed with a plurality of spoke mounting holes, each of which extends from a respective one of the inclined side walls of the spoke mounting sections of the inner wall surface to the outer wall surface in a direction transverse to the respective one of the inclined side walls.

### BRIEF DESCRIPTION OF THE DRAWINGS

Other features and advantages of the present invention will become apparent in the following detailed description of the preferred embodiment with reference to the accompanying drawings, of which:

FIG. 1 is a cross-sectional view of a conventional bicycle hub when mounted with a plurality of spoke fasteners;

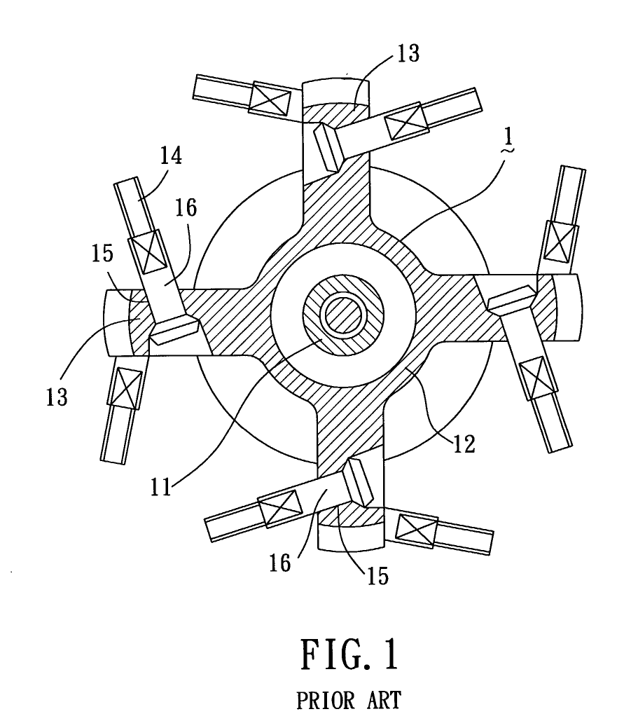

FIG. 2 is a perspective view of a preferred embodiment of a bicycle hub of the present invention when installed on a wheel axle and mounted with a plurality of spokes;

FIG. 3 is an end view of FIG. 2; and

FIG. 4 is a fragmentary perspective view of the preferred embodiment.

### DETAILED DESCRIPTION OF THE PREFERRED EMBODIMENT

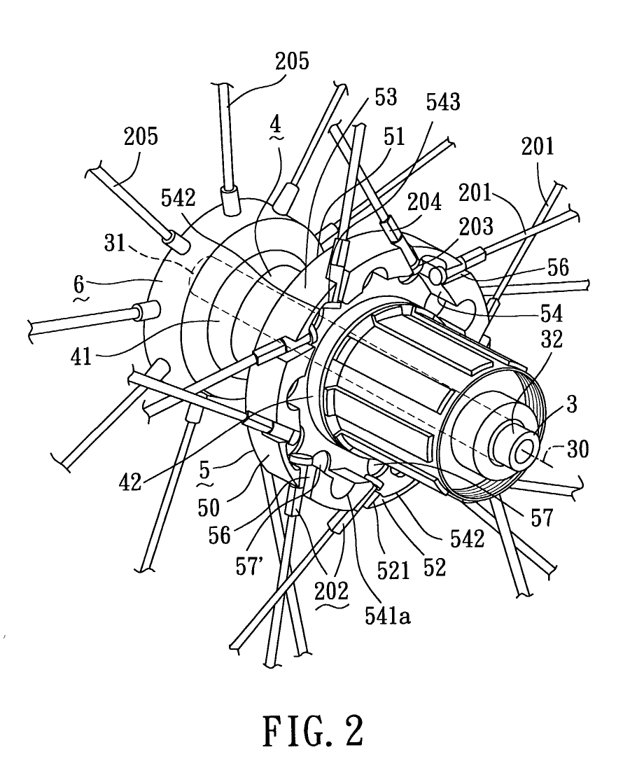

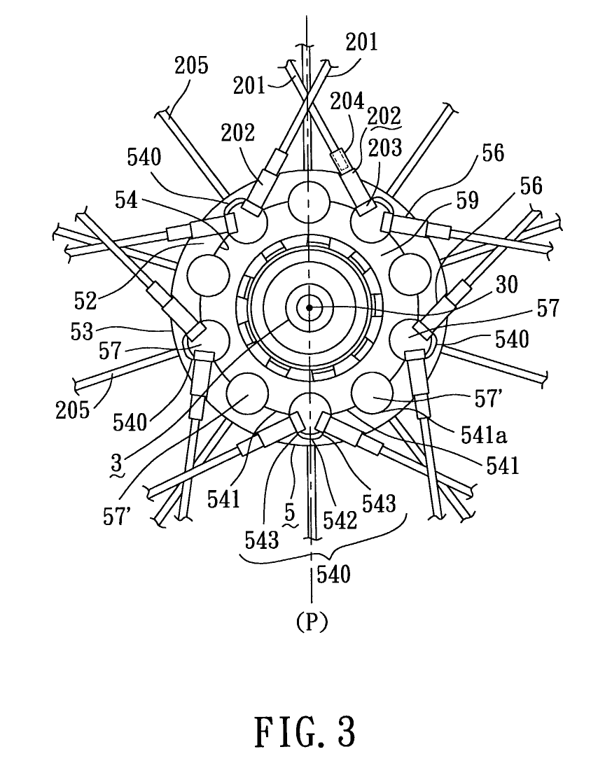

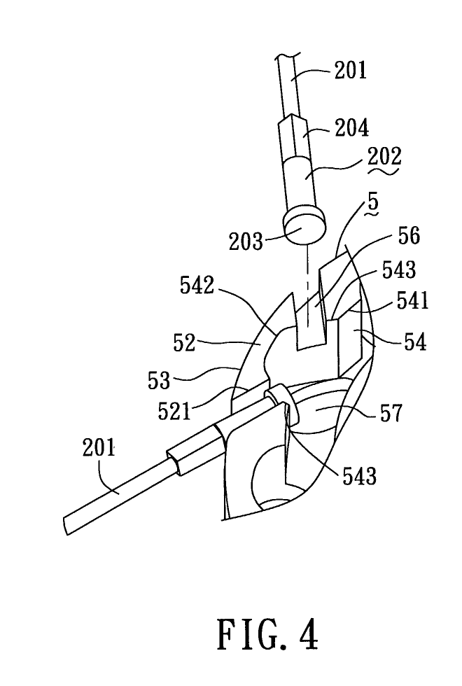

Referring to FIGS. 2 to 4, the preferred embodiment of the bicycle hub according to the present invention is adapted to be installed on a wheel axle 3 that has two opposite ends 31, 32 carried by two prongs of a bicycle fork (not shown), and is shown to include a tubular body 4 and an annular mounting seat 5. The tubular body 4 is adapted to be sleeved rotatably on the wheel axle 3, and has opposite first and second end portions 41, 42 disposed adjacent to the opposite ends 31, 32 of the wheel axle 3, respectively. The first end portion 41 of the tubular body 4 is formed with an annular mounting flange 6 that has a plurality of spokes 205 mounted thereon such that the spokes 205 radiate from the mounting flange 6 in a known manner.

The annular mounting seat 5 is sleeved on the second end portion 42 of the tubular body 4. The mounting seat 5 has an annular mounting sleeve 50 disposed around an axis 30 of the wheel axle 3. The mounting sleeve 50 has a first end wall 51 facing the mounting flange 6 on the first end portion 41 of the tubular body 4, a second end wall 52 opposite to the first end wall 51 along the axis 30 of the wheel axle 3, an inner wall surface 54 facing the axis 30 of the wheel axle 3, and an outer wall surface 53 opposite to the inner wall surface 54 in radial directions relative to the axis 30 of the wheel axle 3.

The inner wall surface 54 includes a plurality of indented spoke mounting sections 540 which are displaced angularly from one another with respect to the axis 30 of the wheel axle 3, and a plurality of connecting sections 541 extending between and interconnecting adjacent pairs of the spoke mounting sections 540. The spoke mounting sections 540 are indented relative to the connecting sections 541 in the radial directions with respect to the axis 30 of the wheel axle 3. Each of the spoke mounting sections 540 of the inner wall surface 54 is defined by a pair of inclined side walls 543 which are spaced apart from each other in a circumferential direction with respect to the axis 30 of the wheel axle 3, and a bottom wall 542 extending between the inclined side walls 543. The inclined side walls 543 are inclined with respect to the bottom wall 542. Preferably, the bottom wall 542 cooperates with an adjacent one of the inclined side walls 542 to define an obtuse angle. The mounting sleeve 50 is formed with a plurality of spoke mounting holes 56, each of which is formed through the inner and outer wall surfaces 54, 53 of the mounting sleeve 50, and extends from a respective one of the inclined side walls 542 of the spoke mounting sections 540 of the inner wall surface 54 to the outer wall surface 53 in a direction generally transverse to the respective one of the inclined side walls 542. In each of the spoke mounting sections 540, the bottom wall 542 has two opposite terminating ends disposed adjacent to the inclined side walls 543, and a central point equally distant from the terminating ends. The inclined side walls 543 are symmetrical to each other with respect to a phantom plane (P) that passes through the central point and through the axis 30 of the wheel axle 3. The second end wall 52 of the mounting sleeve 50 is formed with a plurality of access openings 521, each of which is communicated with a respective one of the spoke mounting holes 56 and extends along the respective spoke mounting hole 56 from the inner wall surface 54 to the outer wall surface 53 of the mounting sleeve 50.

The mounting seat 5 further has an annular flange 59 which extends integrally from the first end wall 51 of the mounting sleeve 50 and which projects radially and inwardly relative to the inner wall surface 54 of the mounting sleeve 50. The annular flange 59 is flush with the first end wall 51. In the present embodiment, in order to reduce the weight of the mounting seat 5, the annular flange 59 is formed with a plurality of slots 57, 57′ therethrough. A first set of the slots 57 are formed respectively adjacent to the indented spoke mounting sections 540 of the inner wall surface 54 of the mounting sleeve 50. A second set of the slots 57′ are formed respectively adjacent to the connecting sections 541 of the inner wall surface 54. Each of the connecting sections 541 has a concave portion 541a registered with the periphery of a respective one of the second set of the slots 57′.

To install spokes 201 on the mounting seat 5, a plurality of spoke fasteners 202 are extended through the spoke mounting holes 56 such that head portions 203 of the spoke fasteners 202 abut respectively against the inclined side walls 543 of the indented spoke mounting sections 540 of the inner wall surface 54. The spokes 201 are then fastened respectively to internally threaded sections 204 of the spoke fasteners 202 opposite to the head portions 203. After installation of the spokes 201 on the hub, each of the spokes 201 intersects with another spoke 201 that is mounted on an adjacent one of the spoke mounting sections 540. The hub thus carries a plurality of intersecting pairs of spokes 201 thereon. The arrangement as such permits tension forces of the spokes 201 to be applied uniformly to the mounting sleeve 50, instead of being concentrated on a certain area of the mounting sleeve 50. Deformation or breakage of the hub is thus prevented.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A bicycle hub adapted to be installed on a wheel axle, said bicycle hub comprising:
a tubular body adapted to be sleeved on the wheel axle and having opposite end portions which are opposite to each other along an axis of the wheel axle; and
an annular mounting seat provided on one of said end portions of said tubular body, said mounting seat having an annular mounting sleeve which is disposed around the axis of the wheel axle and which has a first end wall facing the other one of said end portions of said tubular body, a second end wall opposite to said first end wall along the axis of the wheel axle, an inner wall surface facing the axis of the wheel axle, and an outer wall surface opposite to said inner wall surface in radial directions with respect to the axis of the wheel axle, said inner wall surface including a plurality of indented spoke mounting sections which are displaced angularly from one another and which are indented in the radial directions, each of said spoke mounting sections being defined by a pair of inclined side walls spaced apart from each other in a circumferential direction with respect to the axis of the wheel axle, and a bottom wall extending between said inclined side walls, said inclined side walls being inclined with respect to said bottom wall, said mounting sleeve being formed with a plurality of spoke mounting holes, each of which extends from a respective one of said inclined side walls of said spoke mounting sections of said inner wall surface to said outer wall surface in a direction transverse to the respective one of said inclined side walls.

2. The bicycle hub as claimed in claim 1, wherein said bottom wall of each of said spoke mounting sections of said inner wall surface cooperates with an adjacent one of said inclined side walls to define an obtuse angle.

3. The bicycle hub as claimed in claim 2, wherein said bottom wall of each of said spoke mounting sections has two opposite terminating ends disposed adjacent to said inclined side walls of the respective one of said spoke mounting sections, and a central point equally distant from said terminating ends, said inclined side walls of each of said spoke mounting sections being symmetrical to each other with respect to a plane that passes through said central point and through the axis of the wheel axle.

4. The bicycle hub as claimed in claim 1, wherein said mounting seat further includes an annular flange which extends from said first end wall of said mounting seat and which projects radially and inwardly relative to said inner wall surface of said mounting seat.

5. The bicycle hub as claimed in claim 4, wherein said annular flange has a plurality of slots formed therethrough.

6. The bicycle hub as claimed in claim 1, wherein said second end wall of said mounting sleeve is formed with a plurality of access openings, each of which is communicated with a respective one of said spoke mounting holes and extends along the respective one of said spoke mounting holes from said inner wall surface to said outer wall surface of said mounting sleeve.
